(19) United States
(12) Patent Application Publication
(10) Pub. No.: US 2025/0174215 A1
(43) Pub. Date: May 29, 2025

(54) METHOD FOR ANALYZING ACOUSTICAL SOUND SOURCE OF MUSIC USING MUSICAL ELEMENTS AND DEVICE FOR THE SAME

(71) Applicant: YULLAB INC., Seongnam-si (KR)

(72) Inventor: Nayoung LEE, Seongnam-si (KR)

(73) Assignee: YULLAB INC., Seongnam-si (KR)

(21) Appl. No.: 18/935,050

(22) Filed: Nov. 1, 2024

(30) Foreign Application Priority Data
Nov. 29, 2023 (KR) 10-20230169244
Aug. 28, 2024 (KR) 10-2024-0116124

(51) Int. Cl. G10H 1/00

(52) U.S. Cl. CPC G10H 1/0025

(57) ABSTRACT

According to an exemplary embodiment, the device analyzes music sound sources by loading a sound source, dividing it into multiple phrases, displaying them, extracting pitch contours from selected phrases, dividing them based on pitch changes, and providing the analysis results.

### CROSS-REFERENCE TO RELATED APPLICATIONS

This application claims priority to and the benefit of Korean Patent Application Nos. 10-2023-0169244, filed on Nov. 29, 2023, and 10-2024-0116124, filed on Aug. 28, 2024, in the Korean Intellectual Property Office, the entire contents of which are incorporated herein by reference.

### BACKGROUND

### Field

The present disclosure relates to a method for analyzing an acoustical sound source of a music using musical elements and a device for the same.

### Description of the Related Art

Sanjo is a solo form of traditional Korean music, mainly played on instruments such as the gayageum, geomungo, haegeum, and daegeum. Sanjo is characterized by a gradual increase in tempo from slow rhythmic cycle to fast rhythmic cycle, and emphasizes improvisation and the skill of the performer. Sanjo is a genre that deeply reflects the performer's emotions and interpretation, and is characterized by personal musical expression. Sanjo originated in the late 19th century and has been passed down to this day, and is establishing itself as a representative solo form of traditional Korean music.

Pansori is a traditional Korean musical play performed by one singer and one drummer who plays a drum to tell a story. The singer expresses the characters in the story with various tones and singing styles, and weaves a long story with songs and dialogues. Pansori is traditionally composed of five acts, each of which has a complete story structure. Pansori is characterized by dramatic expression of emotions and interaction with the audience and is listed as a UNESCO Intangible Cultural Heritage of Humanity in Korea.

Jeongak (Court music) is a general term for Korean court music and traditional music enjoyed by the upper class. Jeongak (Court music) is characterized by refined melodies and slow, elegant rhythmic cycle, and is mainly performed with an orchestra. Jeongak includes A-ak, Dang-ak, Hyang-ak and each music has unique historical background and meanings. Jeongak was used in royal ceremonies and banquets.

Minyo (Korean classical folk songs) refers to songs that have been passed down orally among the people among traditional Korean music. Minyo is songs that reflect the characteristics and lifestyles of each region, and the lyrics and melodies are relatively simple and repetitive. Minyo exist in various forms, such as Nodongyo, Nongyo, Yuheungga, and each region has its own unique tone and rhythmic cycles. Minyo is an important element of Korea's cultural identity, and has been passed down across generations and regions.

Japga is a type of traditional music that developed among the common people in the late Joseon Dynasty, and is a long song sung by professional singers. Japga is a form that is a cross between pansori and Minyo, and mainly contains satirical or social content, expresses various emotions and situations. Japga has many of created lyrics which reflect the lives and emotions of common people.

Pungmul is a folk art that includes music and dance that originated from traditional Korean Nongak. Pungmul is played mainly with percussion instruments such as Buk, Janggu, Kkwaenggwari, and Jing, and is mainly used in village community activities, farming, and festivals. Pungmul emphasizes vitality and excitement, and is characterized by dynamic and intense rhythm. Pungmul served the function of uniting and stimulating the community, and today has developed into a form of traditional cultural preservation and performing art.

Gut Music is music used in traditional Korean shamanic rituals, and serves to connect gods and humans. Gut Music is played by shamans (Mudang) in the process of calling and comforting the gods and is a combination of various instruments, singing, and dancing. Gut music is composed differently depending on the purpose of the ritual, and improvisation is a particularly important element and has religious meaning.

Gagok is a type of vocal music enjoyed by the Yangban class during the Joseon Dynasty, and is a form of singing a standardized sijo. Gagok is mainly sung with the accompaniment of instruments such as the daegeum, geomungo, and gayageum, and is characterized by slow and solemn melodies. Gagok is divided into male songs and female songs, and each has different singing style and atmosphere.

Sinawi is a traditional Korean improvisational ensemble music that originated from gut music. Sinawi is characterized by the harmonious simultaneous playing of different melodies by multiple instruments, and the creativity of improvisers is important. Sinawi is played based on certain rhythmic cycles and keys, and the performers freely express the music while maintaining unity throughout. Sinawi began as part of Gut (exorsim).

Jinyangjo is the slowest rhythmic cycle in Korean traditional music, and is mainly used to express a lyrical and calm atmosphere. One rhythmic cycle consists of 24 beats and is characterized by a slow and leisurely rhythm. Jinyangjo is suitable for conveying depth of emotion at the beginning of Sanjo or Pansori, or for slowly telling a story.

Jungmori is one of the rhythms used in traditional Korean music, and has a slow and restricted atmosphere. One rhythmic cycle consists of 12 beats, and although it is faster than Jinyangjo, it still maintains a leisurely rhythm. Jungmori is often used to express the main part in Pansori and Sanjo, and plays a connecting role in the process of gradually heightening emotions.

Gutgeori is a rhythm used in traditional Korean music, and is characterized by a lively and exciting rhythm. One rhythmic cycle consists of 12 beats and Gutgeori is slightly faster than the Jungmori. Gutgeori is mainly used to heighten the mood or excitement in Pungmul, Minyo, and Pansori.

Jajinmori is a fast and active rhythm in traditional Korean music, with each rhythmic cycle consisting of 12 beats. Jajinmori has a faster rhythm than Gutgeori and is often used to express the climax in Pansori or Sanjo. Jajinmori enables dynamic performances and drives the flow of music quickly.

Unlike Western music, Korean traditional music (Gugak) is music with a unique feeling and style that rarely uses harmony. Unlike the three major elements of Western music-melody, rhythm, and harmony-Gugak is music that must find its characteristics in melody and rhythmic cycle. This is possible because Gugak does not have a vertical system of organized harmony. For that reason, Sigimsae can be considered as the most important musical element after melody and rhythmic cycle.

In the broad sense of Sigimsae, it includes expressive functions such as Nonghyeon, Jeonseong, Chuseong, and Toeseong that are given to certain notes for the natural connection or flexible flow of the melody line and the rhythm, or for the sake of splendor and elegance. Furthermore, even special playing techniques in musical instrument performance can be included in the category of Sigimsae.

In Korean traditional music, when the Sigimsae is used appropriately, the Sigimsae not only enriches and glamifies the music, but also has an important musical character that determines the quality of the music. Therefore, a lack of understanding of Sigimsae can lead to significant errors in the creation of modern Gugak music. As such, the Sigimsae is an important element that determines the character of Korean traditional music, but there is a problem in that there is currently no data that analyzes this important Sigimsae acoustically.

### RELATED ART DOCUMENT

### Patent Document

Korean Registered Patent Publication No. 10-2476120 (registered on Dec. 6, 2022, entitled Music analysis method and apparatus for cross-comparing music properties using artificial neural network)
Korean Registered Patent Publication No. 10-2511598 (registered on Mar. 14, 2023, entitled Music property analysis method and apparatus for analyzing music characteristics using artificial neural network)
Korean Unexamined Patent Application Publication No. 10-2015-0074644 (published on Jul. 2, 2015, entitled Low order audio feature extraction apparatus and method for music classification)

### SUMMARY

A technical object of the present disclosure is to provide an acoustic sound source analysis method of music using musical elements and a device therefor which identify objective values forpitch and scale which make up Gugak (Korean traditional music) through the acoustic analysis of music using the classification of musical elements, and secure objective data for framework which makes up the music piece through analysis of the framework that makes up the music piece, and furthermore, prepares Gugak basic data which allows a computer to learn.

In order to achieve the above-described technical object, according to an aspect of the present disclosure, an acoustic sound source analysis device of music using musical elements includes: a sound source loading unit which loads a sound source to be analyzed, a phrase sound source dividing/generating unit which divides the sound source to be analyzed loaded by the sound source loading unit to generate a plurality of phrase sound sources, a sound source analysis unit which extracts a pitch contour of the phrase sound source and analyzes the phrase sound source by dividing the phrase sound source into a plurality of sections according to a temporal changing pattern of the extracted pitch contour, and a sound source analysis result information providing unit which provides result information analyzed by the sound source analysis unit.

The musical element is at least one selected from a group consisting of a melody, a rhythmic cycle, Sigimsae, a system of scales, a timbre, an ornamentation, a rhythm, a melodic line, a harmonic texture, and lyrics.

The sound source analysis unit divides the phrase sound source into major classification sounds according to a pitch contour based on Sigimsae Theory which is the theory for a technique used to connect notes and the major classification sound includes at least one selected from a group including Pyeongeum, Nongeum, Kkukknuneum, Chuseong, Toeseong, and Jeonseong.

In the entire sections of the phrase sound, the sound source analysis unit classifies a section in which a pitch contour has a straight linear shape as Pyeongeum, classifies a section in which a pitch contour has a continuous curved line shape as Nongeum, classifies a section in which a pitch contour has a stepped linear combination shape is classified as Kkukknuneum, classifies a section in which a pitch contour has an upward curved shape as Chuseong, classifies a section in which a pitch contour has a downward curved shape as Toeseong, and classifies a section in which a pitch contour has a discontinuous curved shape as Jeonseong.

The sound source analysis unit classifies the major classification sound into a basic form and a variation according to an attribute of the sound and then classifies major classification sounds excluding Pyeongeum according to a depth or a speed and additionally classifies sounds which are classified as the variation according to a combined form. Here, the device further includes a phrase sound source list display unit which displays a phrase sound source list for identifying the plurality of phrase sound sources generated by the phrase sound source dividing/generating unit through a list displaywindow. When one is selected from the phrase sound source list displayed on the list displaywindow, the phrase sound source list display unit extracts a pitch contour of the phrase sound source corresponding to the selected phrase sound source list and divides the phrase sound source into a plurality of sections according to the temporal changing pattern of the extracted pitch counter to analyze the phrase sound source.

The sound source analysis result informationproviding unit includes: an analysis waveform providing unit which provides an analysis waveform obtained by analyzing a temporal change of a pitch contour of a phrase sound source corresponding to a phrase sound source list, selected from phrase sound source lists displayed through a list display window, in the entire sections, through an analysis waveform display window; and an analysis data providing unit which provides analysis data corresponding to an analysis waveform of the phrase sound source through the analysis data display window.

The analysis data which is provided by the analysis data providing unit through the analysis data display window includes at least one selected from a group including information for identifying classified sounds in the entire section of the phrase sound source, information about occurrence timings and disappearing timings of classified sounds, and information about a duration.

The music is Gugak (Korean traditional music) and Gugak may be at least one selected from a group consisting of Sanjo, Pansori, Jeongak, Minyo (Korean classical folk songs), Japga, Pungmul, Gut music, Gagok, and Sinawi.

In order to achieve the above-described objects, according to an aspect of the present disclosure, a method performed in a device including a memory which stores one or more programs to perform acoustic sound source analysis of music using musical elements and one or more processors which performs operations according to one or more programs includes: a step of loading a sound source to be analyzed, a step of dividing the loaded sound source to be analyzed to generate a plurality of phrase sound sources, a step of analyzing a pitch contour of the phrase sound source and analyzes the phrase sound source by dividing the phrase sound source into a plurality of sections according to a temporal changing pattern of the extracted pitch contour, and a step of providing analyzed result information.

In the step of dividing and analyzing the phrase sound source into a plurality of sections, the phrase sound source is divided into major classification sounds according to a pitch contour based on Sigimsae Theory which is the theory for a technique used to connect notes and the major classification sound includes at least one selected from a group including Pyeongeum, Nongeum, Kkukknuneum, Chuseong, Toeseong, and Jeonseong.

In the step of dividing and analyzing the phrase sound source into a plurality of sections, in the entire sections of the phrase sound, a section in which a pitch contour has a straight linear shape is classified as Pyeongeum, a section in which a pitch contour has a continuous curved line shape is classified as Nongeum, a section in which a pitch contour has a stepped linear combination shape is classified as Kkukknuneum, a section in which a pitch contour has an upward curved shape is classified as Chuseong, a section in which a pitch contour has a downward curved shape is classified as Toeseong, and a section in which a pitch contour has a discontinuous curved shape is classified as Jeonseong.

In order to achieve the above-described objects, according to an aspect of the present disclosure, a computer program is stored in a computer readable recording medium to allow a computer to execute any one of the acoustic sound source analysis method of music using musical elements.

According to the present disclosure, an acoustic sound source analysis method of music using musical elements and a device therefor which identify objective values for pitch and scale which make up Gugak (Korean traditional music) through the acoustic analysis of music using the classification of musical elements, and secure objective data for framework which makes up the music piece through analysis of the framework that makes up the music piece, and furthermore, prepares Gugak basic data which allows a computer to learn are provided.

### BRIEF DESCRIPTION OF THE DRAWINGS

FIG. 1 is a view illustrating an acoustical sound source analysis device of a music using musical elements according to an exemplary embodiment of the present disclosure;

FIG. 2 is a view for explaining exemplary criteria for sound distinction in an exemplary embodiment of the present disclosure;

FIG. 3 is a view illustrating an exemplary execution screen of an acoustical sound source analysis device of a music using musical elements according to an exemplary embodiment of the present disclosure;

FIG. 4 is a view illustrating an exemplary analysis screen of an acoustical sound source analysis device of a music using musical elements according to an exemplary embodiment of the present disclosure;

FIG. 5 is a view illustrating an exemplary configuration of an analysis waveform display window according to an exemplary embodiment of the present disclosure;

FIG. 6 is a view illustrating an exemplary configuration of an analysis data display window according to an exemplary embodiment of the present disclosure; and

FIGS. 7 to 22 are views illustrating a result of analyzing Ji Young Hee style Haegeum Sanjo using an acoustical sound source analysis device or method of a music using musical elements.

### DETAILED DESCRIPTION OF THE EMBODIMENT

Specific structural or functional descriptions of exemplary embodiments in accordance with a concept of the present invention which are disclosed in this specification are illustrated only to describe the exemplary embodiments in accordance with the concept of the present invention and the exemplary embodiments in accordance with the concept of the present invention may be carried out by various forms but are not limited to the exemplary embodiments described in this specification.

Various modifications and changes may be applied to the exemplary embodiments in accordance with the concept of the present invention so that the exemplary embodiments will be illustrated in the drawings and described in detail in the specification. However, the invention is not limited to the specific embodiments, but includes all changes, equivalents, or alternatives which are included in the spirit and technical scope of the present invention.

If it is not contrarily defined, all terms used herein including technological or scientific terms have the same meaning as those generally understood by a person with ordinary skill Terms which are defined in a generally used in the art dictionary should be interpreted to have the same meaning as the meaning in the context of the related art but are not interpreted as an ideally or excessively formal meaning if it is not clearly defined in this specification.

Hereinafter, exemplary embodiments of the present disclosure will be described in detail with reference to accompanying drawings.

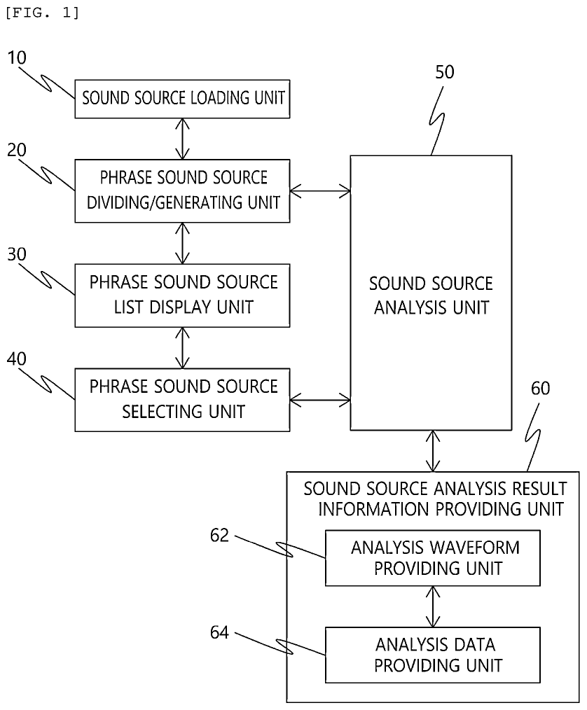

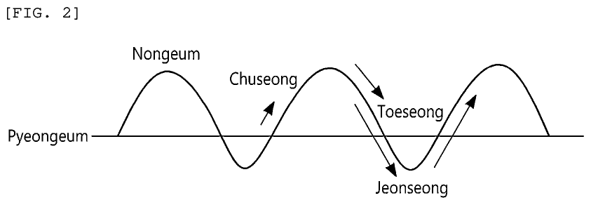

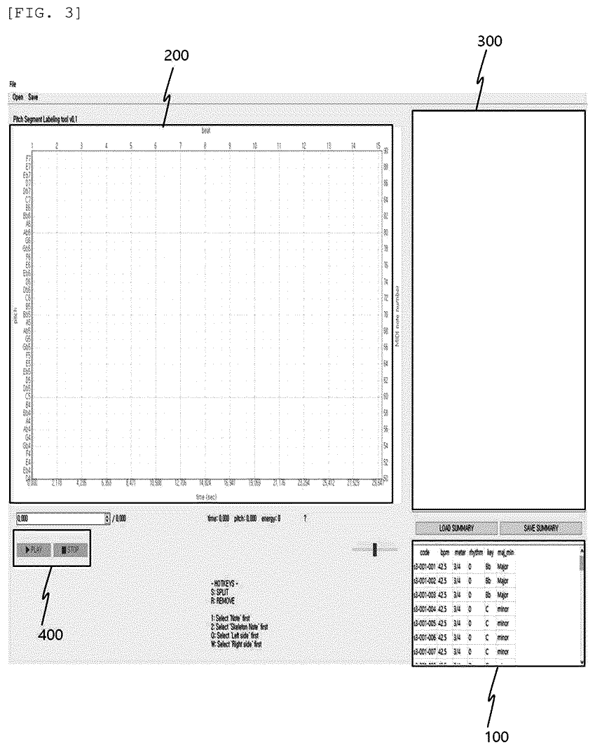

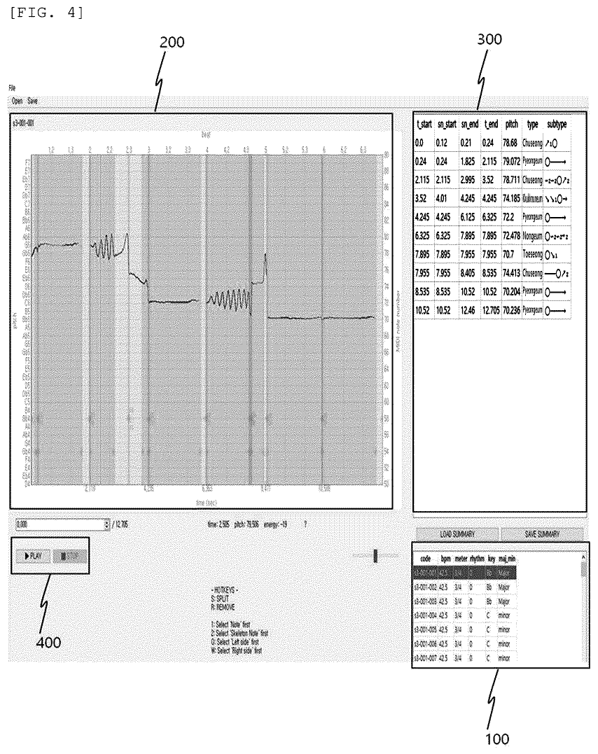

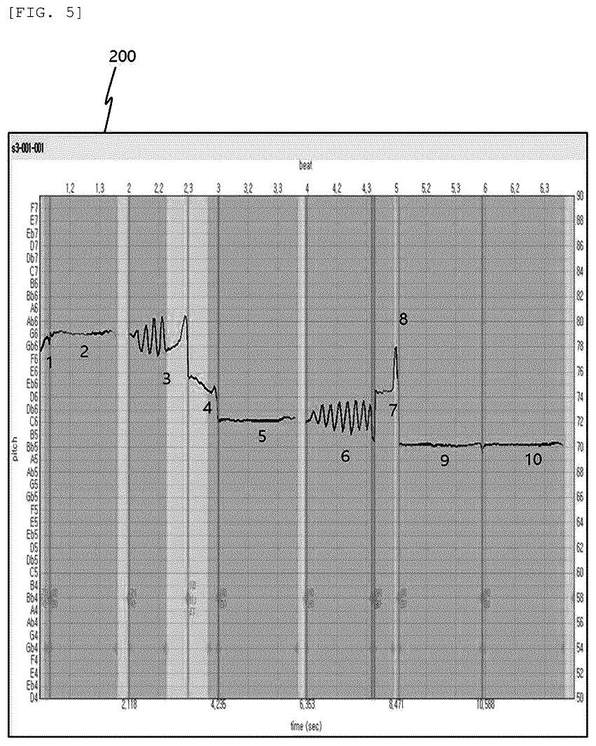

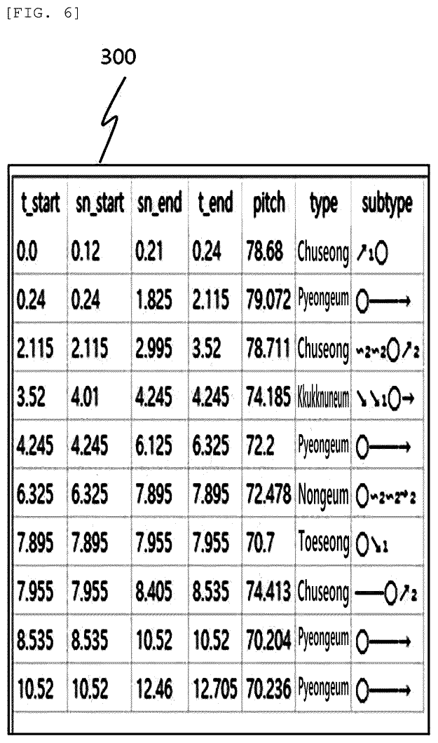

FIG. 1 is a view illustrating an acoustical sound source analysis device of a music using musical elements according to an exemplary embodiment of the present disclosure, FIG. 2 is a view for explaining exemplary criteria for sound distinction in an exemplary embodiment of the present disclosure, FIG. 3 is a view illustrating an exemplary execution screen of an acoustical sound source analysis device of a music using musical elements according to an exemplary embodiment of the present disclosure, FIG. 4 is a view illustrating an exemplary analysis screen of an acoustical sound source analysis device of a music using musical elements according to an exemplary embodiment of the present disclosure, FIG. 5 is a view illustrating an exemplary configuration of an analysis waveform display window according to an exemplary embodiment of the present disclosure, and FIG. 6 is a view illustrating an exemplary configuration of an analysis data display window according to an exemplary embodiment of the present disclosure.

Music to which the present disclosure is applied may be Korean traditional music, but is not necessarily limited thereto and may be traditional music, classical music, modern music, and songs of various countries. To be more specific, the music to which the present disclosure is applied spans a wide range of genres, including traditional music from various countries, as well as Western classical music, jazz, blues, world music, pop music, rock, hip-hop, electronic music, and folk music. For example, a variety of music, such as traditional Japanese music (Gagaku, Japanese court music), traditional Indianmusic (Raga), Middle Eastern makamat, African drum music, Latin American samba and salsa, and European classical opera may be included.

In the present disclosure, Gugak (Korean traditional music) may be at least one selected from a group consisting of Sanjo, Pansori, Jeongak, Minyo (Korean classical folk songs), Japga, Pungmul, Gut music, Gagok, and Sinawi, but is not necessarily limited thereto. Hereinafter, Sanjo which is one example of the Gugak will be mainly described.

In the present disclosure, a musical element may be at least one selected from a group including a melody, a rhythmic cycle, Sigimsae, a systemof scales, a timbre, an ornamentation, a rhythm, a melodic line, a harmonic texture, and lyrics, but is not necessarily limited thereto. Hereinafter, Sigimsae which is one example of the musical element will be mainly described. Referring to FIGS. 1 to 6, the acoustical sound source analysis device of a music using musical elements according to an exemplary embodiment of the present disclosure includes a sound source loading unit 10, a phrase sound source dividing/generating unit 20, a phrase sound source selecting unit 40, a phrase sound source list display unit 30, a sound source analysis unit 50, and a sound source analysis result information providing unit 60. The sound source loading unit 10 is a component which loads a sound source to be analyzed.

The phrase sound source dividing/generating unit 20 is a component which divides a sound source to be analyzed which is loaded by the sound source loading unit 10 to generate a plurality of phrase sound sources.

The phrase sound source list display unit 30 is a component which displays a phrase sound source list for distinguishing the plurality of phrase sound sources generated by the phrase sound source dividing/generating unit 20 on a list display window 100 to the user.

The phrase sound source selecting unit 40 is a component which receives a selection command for one of the phrase sound source list displayed on the list display window 100 from the user to transmit the selection command to the sound source analysis unit 50.

The sound source analysis unit 50 extracts a pitch contour of the phrase sound source and analyzes the phrase sound source by dividing the phrase sound source into a plurality of sections according to a temporal changing pattern of the extracted pitch contour.

The sound source analysis unit 50 is a component which when one is selected from the phrase sound source list displayed on the list display window 100, extracts a pitch contour of the phrase sound source corresponding to the selected phrase sound source list and divides the phrase sound source into a plurality of sections according to the temporal changing pattern of the extracted pitch counter to analyze the phrase sound source. The sound source analysis unit 50 divides the phrase sound source into major classification sound according to the pitch contour based on the Sigimsae theory.

Sigimsae Theory is a theory that systematically explains the techniques used to naturally connect or decorate notes in traditional Korean music. The Sigimsae is not simply a movement of notes, but is considered an important element in expressing the emotion of sounds and adding liveliness to the melody. This theory is essential to understanding the unique aesthetic sensibility and expressive style of Korean music and is particularly important in the performance of traditional instruments such as the gayageum, geomungo, and daegeum.

The Sigimsae theory was originally developed to explain the unique pitch connection techniques and expression methods of Korean traditional music, and is understood and used in the special context of Korean music. The basic concepts of natural connections between sounds, decoration, and emotional expression are universal musical elements and can be applied in similar ways to the music of other cultures.

For example, in the case of Western music, techniques, such as portamento or glissando, can be seen as playing a role similar to Sigimsae. Accordingly, the principle or concepts of the Sigimsae theory may be applied to other traditional music. A major classification sound may be a concept including at least one selected from a group including Pyeongeum, Nongeum, Kkukknuneum, Chuseong, Toeseong, and Jeonseong.

The sound source analysis unit 50 classifies a section in which a pitch contour has a straight linear shape as Pyeongeum, a section in which a pitch contour has a continuous curved line shape as Nongeum, a section in which a pitch contour has a stepped linear combination shape as Kkukknuneum, a section in which a pitch contour has an upward curved shape as Chuseong, a section in which a pitch contour has a downward curved shape as Toeseong, and a section in which a pitch contour has a discontinuous curved shape as Jeonseong, in the entire sections of the phrase sound. The sound source analysis unit 50 determines that even though there is a slight variation in the pitch contour, if the pitch change is maintained within a range within a predetermined reference range (for example, within a range of + or −5 cents from a straight line) or the pitch change speed is slower than a predetermined reference speed (for example, 1 cent per second), the sound source analysis unit 50 considers that there is a slight variation and it is a section in which the pitch contour has a straight line shape to classify as Pyeongeum.

The sound source analysis unit 50 classifies the pitch contour into a major classification sound using an artificial intelligence technique. For example, the pitch contour analysis and the major classification sound classification by utilizing artificial intelligence re performed by machine learning or a deep learning model. This method is based on an ability of recognizing and classifying various patterns of the pitch contour by learning a large amount of sound source data. The artificial intelligence model which is used by the sound source analysis unit 50 to classify the pitch contour into major classification sounds is generated by the following method: In a first step, pitch contour data of various sound sources are collected during the data collecting and pre-processing process and learning data labeled tomajor classification sounds, such as Pyeongeum, Nongeum, and Kkukknuneum is generated based on the data. The pitch contour is mainly expressed as data in a time-frequency domain and is transformed to be processed by a neural network model. During this process, a task of standardizing a length of the contour or extracting a feature may be included. Hear, pitch contour data for learning may be image data, but is not necessarily limited thereto.

In a second step, during the model learning process, pitch contour data is learned using a deep learning model, such as a convolutional neural network (CNN) or a recurrent neural network (RNN). The learning process is performed by matching various shapes of the pitch contour and major classification sounds corresponding thereto and the model may have an ability of sensing a minute change of the pitch contour and accurately classifying the pitch contour by the repeated learning.

Finally, the sound source analysis unit 50 analyzes a pitch contour of a new sound source and predicts a major classification sound in real time using the artificial intelligence model. The artificial intelligence model analyzes the input pitch contour to automatically classify the pitch contour into Pyeongeum, Nongeum, and Kkukknuneum according to the shapes and provide the result.

For example, the sound source analysis unit 50 is configured to classify the major classification sound into a basic form and a variation by an attribute of the sound, and then classify the major classification sound excluding Pyeongeum according to a depth and a speed, and additionally classify a sound which is classified as a variation according to a combined shape. Each phrase sound source may be played by manipulating a phrase sound source play button 400.

This configuration will be specifically and illustratively described by connecting with the Sigimsae.

### 1. Sigimsae Classification

A performance tendency of Korean music has a tendency of consistently changing an attribute of sound by a temporal combination of a sound on a horizontal line and regular or irregular sounds. A low attribute has a pitch and an energy and the low attributes are combined to show an attribute of a high technique. As basic attributes, there are stop, up, down, and oscillation and in each attribute, a speed, a depth, and a duration are combined in various forms. Higher attributes are shown by the combination of these units. An exemplary embodiment of the present disclosure analyzes Ji Young Hee Haegeum Sanjo based on the classification of the attributes.

### 2. Classification Criterion According to Sigimsae Classification

### (1) Sound Classification

Referring to FIG. 2 which illustrates an exemplary criterion of sound classification, a criterion of sound classification may be roughly divided into stop and move. The only sound that corresponds to a still sound is Pyeongeum, which can be judged by the continuity of the straight line included in the pitch contour.

### (2) Major Category

A sound which corresponds to a moving sound is Nongeum, Kkukknuneum, Jeonseong, Chuseong, and Toeseong and can be judged by the continuity of the curve included in the pitch contour, and this is called a major category.

Pyeongeum is a sound with a relatively constant property that is shown in the form of a straight line on the pitch contour, Nongeum is a sound with a property that is shown in the form of a continuous curve on the pitch contour, Kkukknuneum is a sound with a property that is shown in the form of a stepped straight combination on the pitch contour, Chuseong is a sound with a property that is shown in the form of an upward curve on the pitch trajectory, Toeseong is a sound with a property that is shown in the form of a downward curve on the pitch contour, and Jeonseong is a sound with a property that is shown in the form of a non-continuous curve on the pitch contour.

### (3) Sub-Category

Respective sounds classified into major categories are divided into basic and variation and the remaining sounds other than Pyeongeum are classified into basic and variation and then are divided by a depth or a speed depending on the properties. These are also classified into simply variation or combined variation depending on the combination type of the major classification sounds. This is called sub categories.

In Table 1, a sound classification criterion according to the above-described Sigimsae theory.

TABLE 1

| Still | Pyeongeum | Basic | | Short Pyeongeum | |
|---|---|---|---|---|---|
| | | | | Normal Pyeongeum | |
| | | | | Long Pyeongeum | |
| | | Variation | | Haegeum specific | |
| | | | | Continuous | |
| | | | | Pyeongeum | |
| Moving | Nongeum | Basic | Depth | Regular shallow | |
| | | | | Nongeum | |
| | | | | Regular normal | |
| | | | | Nongeum | |
| | | | | Regular deep | |
| | | | | Nongeum | |
| | | | Speed | Regular fast | |
| | | | | Nongeum | |
| | | | | Gradually faster | |
| | | | | Nongeum | |
| | | Variation | | Nongeum after | Combined |
| | | | | Pyeongeum | Variation: |
| | | | | | Pyeongeum + Nongeum |
| | Kkukknuneum | Basic | Depth | Kkukknuneum | |
| | | | Three | | |
| | | | key-Kkukknuneum | | |
| | | | Four | | |
| | | | key-Kkukknuneum | | |
| | | Speed | Short Kkukknuneum | | |
| | | | Long Kkukknuneum | | |
| | | Variation | Depth | Nongeum after deep | Combined |
| | | | | Kkukknuneum | variation: |
| | | | | | Kkukknuneum + |
| | | | | | Nongeum |
| | | | | Chuseong after | Combined |
| | | | | Kkukknuneum | variation: |
| | | | | | Kkukknuneum + |
| | | | | | Chuseong |
| | | | Speed | Fast Nongeum after | Combined |
| | | | | Kkukknuneum | variation: |
| | | | | | Kkukknuneum + |
| | | | | | Fast Nongeum |
| | Chuseong | Basic | Depth | Not classified | |
| | | | Speed | Normal Chuseong | |
| | | | | Fast Chuseong | |
| | | Variation | Depth | Chuseong after | Combined |
| | | | | Nongeum | variation: Nongeum + |
| | | | | | Chuseong |
| | | | | Deep Chuseong | Combined |
| | | | | after Pyeongeum | variation: |
| | | | | | Pyeongeum + |
| | | | | | Chuseong |
| | | | | Shallow Chuseong | Combined |
| | | | | after Pyeongeum | variation: |
| | | | | | Pyeongeum + |
| | | | | | Chuseong |
| | | | Speed | No data | |
| | Toeseong | Basic | Depth | Deep Toeseong | |
| | | | | Toeseong | |
| | | | Speed | Lack of data | |
| | | Variation | Depth | Toeseong after | Combined |
| | | | | Nongeum | variation: Nongeum + |
| | | | | | Toeseong |
| | | | | Toeseong after | Combined |
| | | | | Pyeongeum | variation: |
| | | | | | Pyeongeum + |
| | | | | | Toeseong |
| | Jeonselong | Basic | Speed | Jeonseong | |
| | | | Depth | Constant | |
| | | Variation | Depth | Nongeum after | Combined |
| | | | | Jeonseong | variation: Nongeum + |
| | | | | | Jeonseong |
| | | | Speed | Constant | |

The sound source analysis unit 50 converts a classification or analysis result into symbols. The sound source analysis unit 50 converts a classified major classification sound into symbols. The sound source analysis unit 50 converts a classification or analysis result into symbols based on a skeletal sound.

In the music theory, skeletal sounds refer to sounds which play a fundamental or primary role. These are the sounds that form the center of the melody or harmony, and are the key sounds that determine the structure or flow of the song. The skeletal sounds are used in a way that other ornamentation or auxiliary sounds change or decorate around them while maintaining the basic form or flow of the music. For example, in Korean traditional music, the sounds that form the basic framework of a rhythmical cycle can be considered as skeletal sounds. These sounds form a theme or a main melody of the song and serve as the backbone of the music.

The sound source analysis unit 50 expresses a symbol which represents the skeletal sound with a circle, but is not necessarily limited thereto and may be expressed with symbols, such as a rectangle, a triangle, a diamond, or a star shape. When Pyeongeum is represented, the sound source analysis unit 50 may create a symbol diagramming that the sound is constantly maintained. For example, the Pyeongeum may be diagrammed with a straight line or an arrow and the arrow is diagrammed to indicate a right direction and the straight line is diagrammed to be long in a horizontal direction.

When the Nongeum or the Jeonseong is represented, the sound source analysis unit 50 may create a symbol diagramming that the sound is not constant, but is shaken or vibrates. For example, a symbol which represents the Nongeum or the Jeonseong may have a zigzag pattern or a wavy shape and the zigzag pattern or the wavy shape may be diagrammed to be connected to an arrow and the arrow may be diagrammed to indicate the right direction. When the Kkukknuneum is represented, the sound source analysis unit 50 may create a symbol which visually diagrams that a pitch of the sound is curved downward and then is stabilized. For example, the symbol representing the Kkukknuneum is diagrammed by a straight line or arrow pointing from the upper left to the lower right and a symbol representing a skeletal sound following the straight line or arrow.

When the Toeseong is represented, the sound source analysis unit 50 creates a symbol which visually diagrams that the sound is stabilized and then the pitch of the sound is curved downward. For example, the symbol representing the Toeseong is diagrammed by a straight line or arrow pointing from the upper left to the lower right, followed by a symbol representing a skeletal sound.

When the Chuseong is represented, the sound source analysis unit 50 creates a symbol which visually diagrams that the sound is stabilized and then the pitch of the sound is curved upward or the pitch of the sound is curved upward and then the sound is stabilized. For example, the symbol representing the Chuseong is diagrammed by a straight line or arrow pointing from the lower left to the upper right, followed by a symbol representing a skeletal sound or the symbol representing a skeletal sound, followed by a straight line or an arrow pointing from the lower left to the upper right.

The sound source analysis unit 50 diagrams the major classification sounds to be processedbypresenting the numerical value corresponding to the depth or the length of the major classification sound with the diagrammed symbol.

In the major classification sound, the depth means a strength or a degree of change or movement of the sound. For example, when a sound is bent or vibrates, if a changing range is large and strong, it is expressed as having a deep depth. It represents a situation that the pitch of the sound varies in a large range or the strength of the sound significantly changes. In contrast, when the depth is shallow, it means that such changes are relatively small or subtle.

In the major classification sound, the length represents a duration time of the sound, that is, how long the sound lasts. It indicates a time until the sound stops after the sound begins. If the sound lasts a long time, it is said to be long, and if it lasts a short time, it is said to be short.

The numerical value representing the depth of the major classification sound and the numerical value representing the length of the major classification sound can be expressed to be distinguished from each other. For example, the number representing a depth is denoted by subscript, and the number indicating length may be indicated by a superscript. Further, the number representing the depth is generally denoted and the number representing the length may be denoted in parentheses. The sound source analysis information providing unit 60 or the analysis data providing unit 64 provides a symbol diagramed by the sound source analysis unit 50 as a result of analyzing the sound source as described above.

The diagramed symbol generated through the present disclosure may play an important role to analyze a digital music and process artificial intelligence based sound data. Such a symbolizing system digitizes complex traditional music, such as Gugak to be converted into quantitative data to provide data which allows an artificial intelligence algorithm to learn and analyze the pattern of the music. Specifically, musical elements expressed with symbols may be utilized in various artificial intelligence application programs, such as automated music classification, composition, or sound source generation. By doing this, digital sound database of various traditional music is constructed and the accessibility to the global sound platform is increased. These diagrammatic techniques may support efficient sound source analysis and classification in music search engines, speech recognition systems, and other electronic music processing applications, and may also contribute to the process of automatically analyzing and visualizing complex musical changes.

The sound source analysis result information providing unit 60 is a component that provides result information analyzed by the sound source analysis unit 50.

For example, the sound source analysis result information providing unit 60 includes an analysis waveform providing unit 62 and an analysis data providing unit 64.

The analysis wave form providing unit 62 provides an analysis waveform obtained by analyzing a temporal change of a pitch contour of a phrase sound source corresponding to a phrase sound source list, selected from phrase sound source lists displayed through a list display window 100, in the entire sections, through an analysis waveform display window 200.

The analysis data providing unit 64 provides analysis data corresponding to the analysis waveform of the phrase sound source through the analysis data display window 300.

For example, the analysis data which is provided by the analysis data providing unit 64 through the analysis data display window 300 includes at least one selected from a group including information for identifying classified sounds in the entire section of the phrase sound source, information about occurrence timings and disappearing timings of classified sounds, and information about a duration.

The information for identifying classified sounds in the entire section of the phrase sound source refers to data which classifies sounds in the phrase sound source according to a specific criteria and identifies which type each sound belongs to. The information for identifying classified sounds in the entire section of the phrase sound source includes data provided to classify the sounds into Pyeongeum, Nongeum, Kkukknuneum, Chuseong, Toeseong, and Jeonseong and identify where the classified sounds are located in the phrase.

Additional analysis data provided by the sound source analysis result information providing unit 60 or the analysis data providing unit 64 may include information about a major classification sound and a sub classification sound. The major classification sounds are classified into Pyeongeum, Nongeum, Kkukknuneum, Chuseong, Toeseong, and Jeonseong and a sub classification result for them is also provided. The sub classification result includes a basic form and variation of each major classification sound and a combined pattern of the variations.

Further, information about a frequency and a distribution according to the classification result of each sound is also provided. This is a result obtained by analyzing how frequently a specific sound occurs in the entire phrase and is efficient to identify a ratio of main sounds and auxiliary sounds. Finally, analysis data according to a combined form of the major classification sound and a sub classification sound may be included. This is a result obtained by analyzing a combined form of a plurality of sub classification sounds and is used to identify a changing pattern of a complex sound and an occurrence timing.

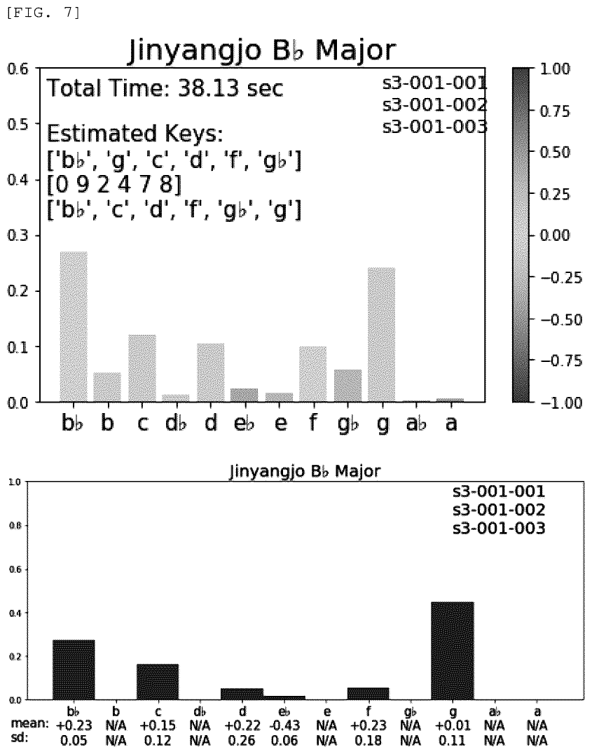

Hereinafter, further referring to FIGS. 7 to 22, a result of analyzing Ji Young Hee style Haegeum Sanjo using an acoustical sound source analysis device of Sanjo using Sigimsae classification according to an exemplary embodiment of the present disclosure will be described as an example.

FIGS. 7 to 10 illustrate an analysis result of a central note and a scale analysis result of Jinyangjo.

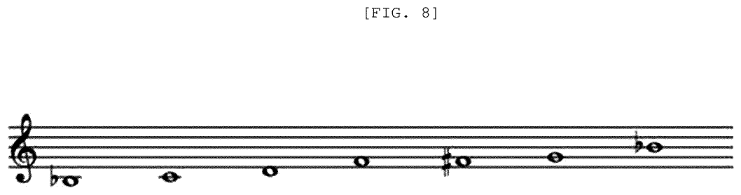

Referring to an example of FIG. 7, when a criterion of Western music is applied, a major scale which appears in Jinyangjo of Ji Young Hee style Haegeum Sanjo is composed of Bb major with a central note being Bb, and the frequency of appearance of the notes being in the order of Bb, G, C, F, and Gb. Through this analysis, the major scale of Jinyangjo of Ji Young Hee style Haegeum Sanjo can be explained based on Western music and the scales are illustrated in FIG. 8.

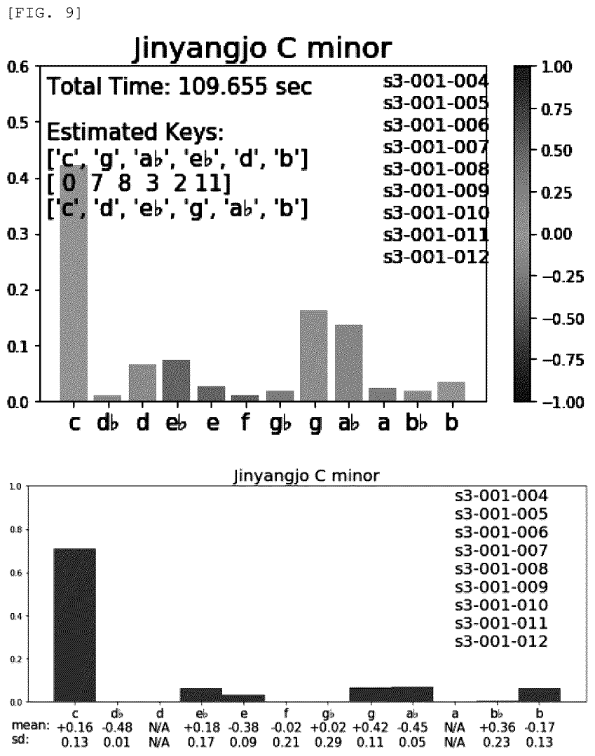

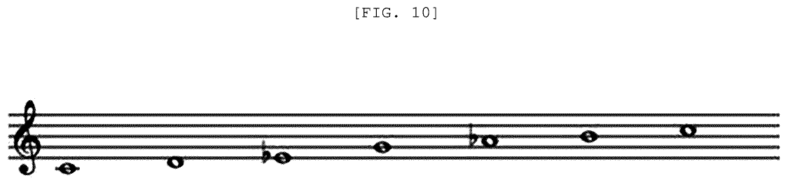

Referring to an example of FIG. 9, when a criterion of Western music is applied, a minor scale which appears in Jinyangjo of Ji Young Hee style Haegeum Sanjo is composed of C minor with a central note being C, and the frequency of appearance of the notes being in the order of C, G, Ab, Eb, D, and B. Through this analysis, the minor scale of Jinyangjo of Ji Young Hee style Haegeum Sanjo can be explained based on Western music and the scales are illustrated in FIG. 10.

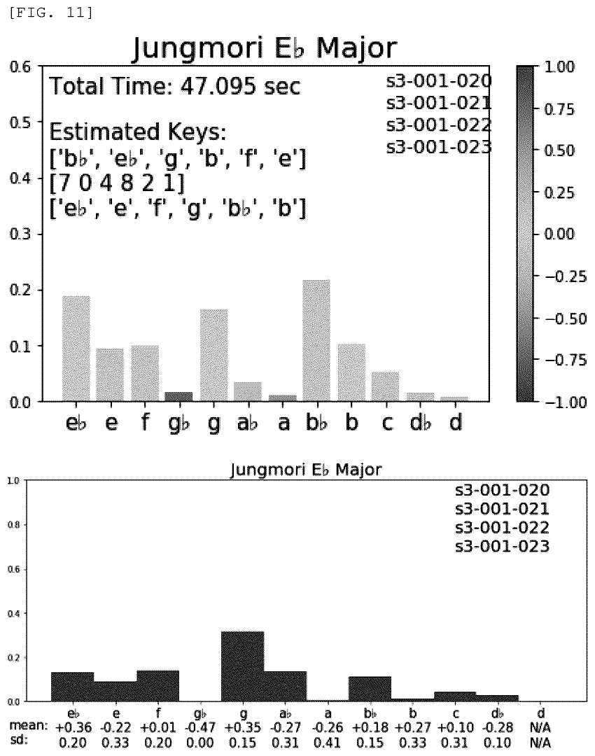

FIGS. 11 to 14 illustrate an analysis result of a central note and a scale analysis result of Jungmori.

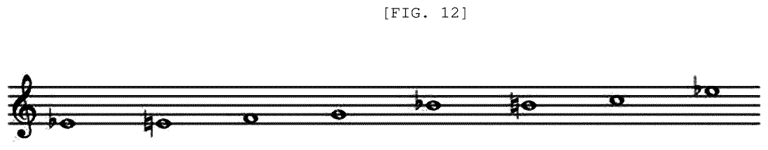

Referring to an example of FIG. 11, when a criterion of Western music is applied, a major scale which appears in Jungmori of Ji Young Hee style Haegeum Sanjo is composed of Eb major with a central note being Bb, and the frequency of appearance of the notes being in the order of Bb, Eb, C, G, B, F, and E. Through this analysis, the major scale of Jungmori of Ji Young Hee style Haegeum Sanjo can be explained based on Western music and the scales are illustrated in FIG. 12.

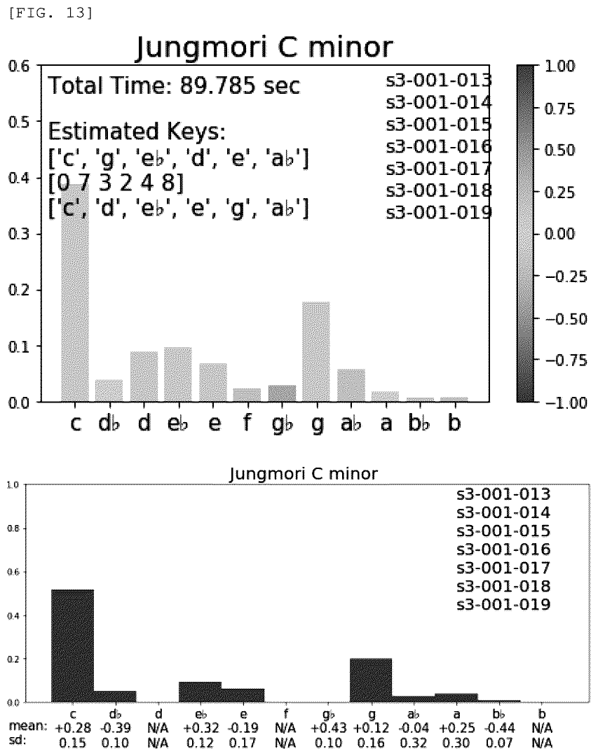

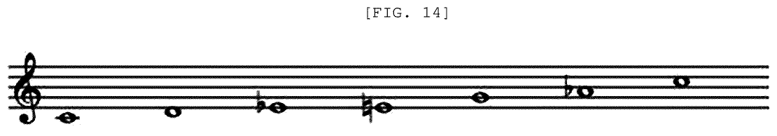

Referring to an example of FIG. 13, when a criterion of Western music is applied, a minor scale which appears in Jungmori of Ji Young Hee style Haegeum Sanjo is composed of C minor with a central note being C, and the frequency of appearance of the notes being in the order of C, G, Eb, D, E, and Ab. Through this analysis, the minor scale of Jungmori of Ji Young Hee style Haegeum Sanjo can be explained based on Western music and the scales are illustrated in FIG. 14.

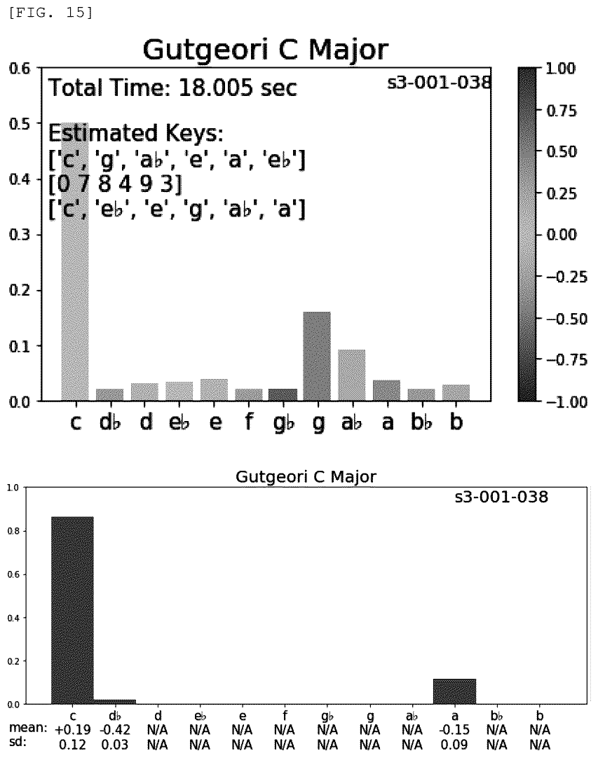

FIGS. 15 to 20 illustrate an analysis result of a central note and a scale analysis result of Gutgeori.

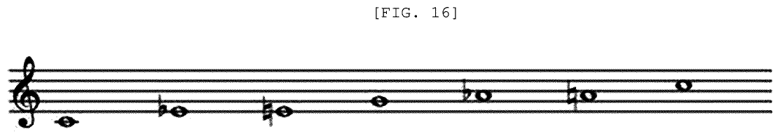

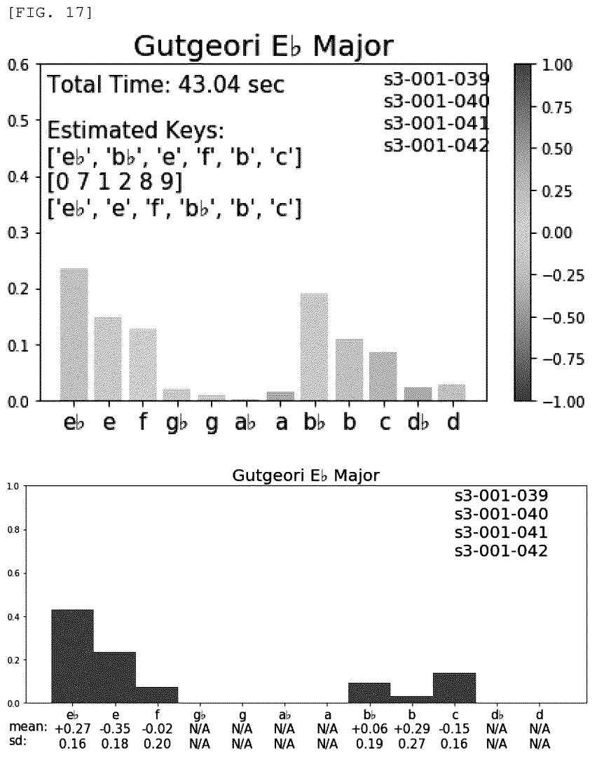

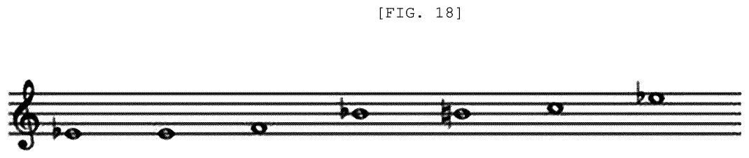

Referring to FIGS. 15 and 17, when the criterion of Western music is applied, a major scale which appears in Gutgeori of Ji Young Hee style Haegeum Sanjo is composed of C major and Eb major with central notes being C and Eb, and the frequency of appearance of the notes being in the order of C, G, Ab, E, A, and Eb for Cmajor and Eb, Eb, E, F, B, and C for Eb major. Through this analysis, the major scale of Gutgeori of Ji Young Hee style Haegeum Sanjo can be explained based on Western music and the scales are illustrated in FIGS. 16 and 18.

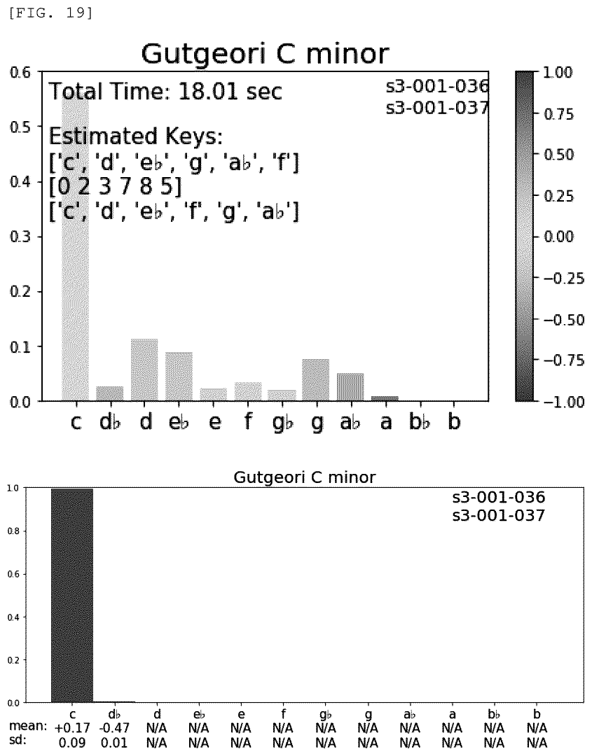

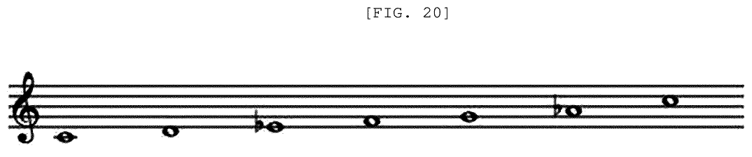

Referring to an example of FIG. 19, when a criterion of Western music is applied, a minor scale which appears in Gutgeori of Ji Young Hee style Haegeum Sanjo is composed of C minor with a central note being C, and the frequency of appearance of the notes being in the order of C, D, Eb, G, Ab, and F. Through this analysis, the minor scale of Gutgeori of Ji Young Hee style Haegeum Sanjo can be explained based on Western music and the scales are illustrated in FIG. 20.

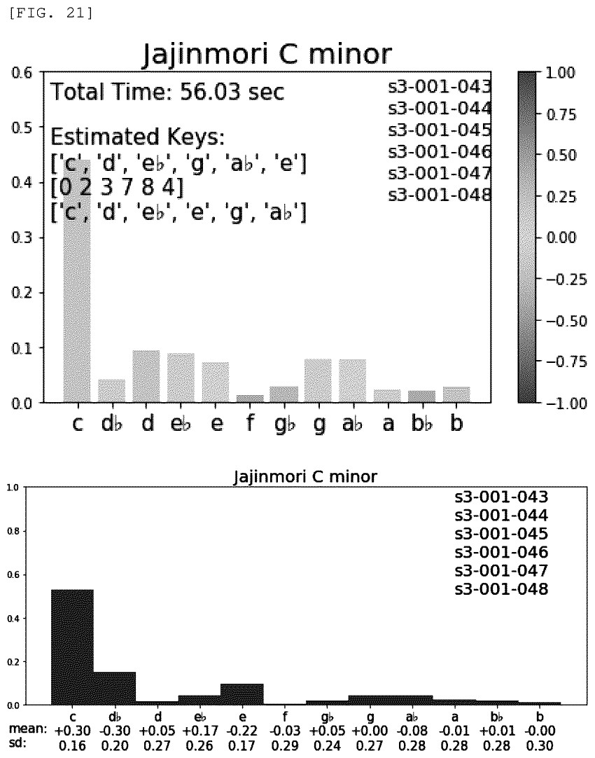

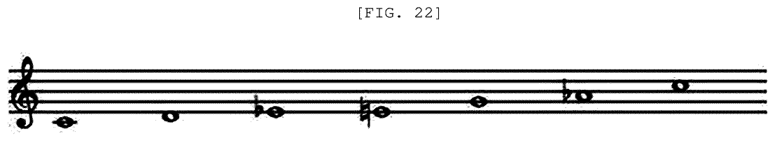

FIGS. 21 and 22 illustrate an analysis result of a central note and a scale analysis result of Jajinmori.

Referring to an example of FIG. 21, the only scale that appears in Jajinmori of Ji Young Hee style Haegeum Sanjo is the minor scale, based on the currently analyzed data when a criterion of Western music is applied, a minor scale which appears in Gutgeori of Ji Young Hee style Haegeum Sanjo is composed of C minor with a central note being C, and the frequency of appearance of the notes being in the order of C, D, Eb, G, Ab, and F. Through this analysis, the minor scale of Jajinmori of Ji Young Hee style Haegeum Sanjo can be explained based on Western music and the scales are illustrated in FIG. 22.

According to an exemplary embodiment of the present disclosure, the results of acoustic analysis of the Ji Young Hee style Haegeum Sanjo among Korean folk music, based on the classification of Sigimsae, are as follows:

Among the constituent notes of Ji Young Hee style Haegeum Sanjo, six notes that appeared the most in terms of time were Bb, G, C, D, F, and Gb in this order. Further, the difference between the 1st and 2nd most frequently appearing notes in terms of time was 7 semitones (a perfect fifth). Further, discrimination of Pyeongjo, Woojo, and Gyemyeongjo also showed significant results. In terms of the discrimination criteria, 1 semitone appeared significantly in the case of Major, and 4 semitones (major third) appeared significantly more than 3 semitones (minor third). In the case of minor, three semitones appeared more than 4 semitones, and 2 and 3 semitones appeared in similar proportions. This is likely to be related to the emergence of Kkukknuneum.

As a result of specifically analyzing appearance of sounds and their proportions by rhythm, the scales that make up each rhythm were identified. The results showed that Jinyangjo is composed of Bb major and C minor, Jungmori is composed of Eb major and C minor, and Gutgeori uniquely shows two major scales, C major and Eb major, and C minor as the minor scale.

In the case of Jajinmori, only the C minor scale was identified, but since this is not an analysis of the entire Jajinmori section of Ji Young Hee style Haegeum Sanjo, it cannot be confirmed as the only scale that appears in the musical piece.

The acoustic sound source analysis method of music using musical elements may be performed in a device which includes a memory which stores one or more programs to analyze an acoustic sound source of music using musical elements and one or more processors which performs operations according to one or more program.

The acoustic sound source analysis method of music using musical elements includes: a step of loading a sound source to be analyzed, a step of dividing the loaded sound source to be analyzed to generate a plurality of phrase sound sources, a step of extracting a pitch contour of the phrase sound source and analyzing the phrase sound source by dividing the phrase sound source into a plurality of sections according to a temporal changing pattern of the extracted pitch contour, and a step of providing analyzed result information.

In the step of dividing and analyzing the phrase sound source into a plurality of sections, the phrase sound source is divided into major classification sounds according to a pitch contour based on Sigimsae Theory and the major classification sound includes at least one selected from a group including Pyeongeum, Nongeum, Kkukknuneum, Chuseong, Toeseong, and Jeonseong.

In the step of dividing and analyzing the phrase sound source into a plurality of sections, in the entire sections of the phrase sound, a section in which a pitch contour has a straight linear shape is classified as Pyeongeum, a section in which a pitch contour has a continuous curved line shape is classified as Nongeum, a section in which a pitch contour has a stepped linear combination shape is classified as Kkukknuneum, a section in which a pitch contour has an upward curved shape is classified as Chuseong, a section in which a pitch contour has a downward curved shape is classified as Toeseong, and a section in which a pitch contour has a discontinuous curved shape is classified as Jeonseong.

That is, the processor performs operations performed in an acoustic sound source analysis device of music using musical elements which has been described with reference to FIGS. 1 to 22 and for example, performs operations performed in the sound source loading unit, the phrase sound source dividing/generating unit, the phrase sound source list display unit, the phrase sound source selecting unit, the sound source analysis unit, the sound source analysis result providing unit, the analysis waveform providing unit, and the analysis data providing unit.

The application also provides a computer storage medium. In the computer storage medium, a program instruction is stored and when the program instruction is executed by a processor, the above-described acoustic sound source analysis method of music using musical elements is implemented.

The computer storage medium according to the exemplary embodiment of the present disclosure may be a U disk, a SD card, a PD optical drive, a mobile hard disk, a high-capacity floppy drive, a flash memory, a multimedia memory card, or a server, but is not necessarily limited thereto.

According to the present disclosure, it is possible to present a pitch standard that meets international standards by comparing Korean traditional music to Western music, and also to present a scale that meets international standards, and furthermore, it is possible to analyze the average frequency of each note. Through this, it will be possible to establish a standard theory for the internationalization of Korean traditional music that has been lacking so far, and the data obtained through this analysis process has practical values for industrial use and historical record value necessary for the times as basic data on Korean traditional music, and additionally, through analysis of other instruments (gayageum, geomungo, daegeum, ajaeng, piri, janggu, etc.) or vocal music (pansori, folk songs, jeongga, etc.), it is also possible to conduct academic analysis on the history of Korea that was previously unknown.

As described above in detail, according to the present disclosure, through the acoustic analysis of Sanjo using the classification of Sigimsae, objective values can be identified for the pitch and scale that make up Sanjo, and objective data can be secured through analysis of the skeleton that makes up the musical piece, and furthermore, a device for analyzing an acoustic sound source of Sanjo using the classification of Sigimsae can be provided to provide basic data on Korean traditional music to allow computers to learn.

What is claimed is:

1. An acoustic sound source analysis device of music using musical elements comprising:
a sound source loading unit which loads a sound source to be analyzed;
a phrase sound source dividing/generating unit which divides the sound source to be analyzed loaded by the sound source loading unit to generate a plurality of phrase sound sources;
a sound source analysis unit which extracts a pitch contour of the phrase sound source and analyzes the phrase sound source by dividing the phrase sound source into a plurality of sections according to a temporal changing pattern of the extracted pitch contour, and
a sound source analysis result information providing unit which provides result information analyzed by the sound source analysis unit.

2. The acoustic sound source analysis device of music using musical elements according to claim 1, wherein a musical element is at least one selected from a group consisting of a melody, a rhythmic cycle, Sigimsae, a system of scales, a timbre, an ornamentation, a rhythm, a melodic line, a harmonic texture, and lyrics.

3. The acoustic sound source analysis device of music using musical elements according to claim 2, wherein the sound source analysis unit divides the phrase sound source into major classification sounds according to a pitch contour based on Sigimsae Theory which is the theory for a technique used to connect notes and the major classification sound includes at least one selected from a group including Pyeongeum, Nongeum, Kkukknuneum, Chuseong, Toeseong, and Jeonseong.

4. The acoustic sound source analysis device of music using musical elements according to claim 3, wherein in the entire sections of the phrase sound, the sound source analysis unit classifies a section in which a pitch contour has a straight linear shape as Pyeongeum, classifies a section in which a pitch contour has a continuous curved line shape as Nongeum, classifies a section in which a pitch contour has a stepped linear combination shape as Kkukknuneum, classifies a section in which a pitch contour has an upward curved shape as Chuseong, classifies a section in which a pitch contour has a downward curved shape as Toeseong, and classifies a section in which a pitch contour has a discontinuous curved shape as Jeonseong.

5. The acoustic sound source analysis device of music using musical elements according to claim 3, wherein the sound source analysis unit classifies the major classification sound into a basic form and a variation according to an attribute of the sound and then classifies major classification sounds excluding Pyeongeum according to a depth or a speed and additionally classifies sounds which are classified as the variation according to a combined form.

6. The acoustic sound source analysis device of music using musical elements according to claim 1, further comprising:
a phrase sound source list display unit which displays a phrase sound source list for identifying the plurality of phrase sound sources generated by the phrase sound source dividing/generating unit through a list display window,
wherein when one is selected from the phrase sound source list displayed on the list display window, the sound source analysis unit extracts a pitch contour of the phrase sound source corresponding to the selected phrase sound source list and divides the phrase sound source into a plurality of sections according to the temporal changing pattern of the extractedpitch counter to analyze the phrase sound source.

7. The acoustic sound source analysis device of music using musical elements according to claim 6, wherein the sound source analysis result information providing unit includes:
an analysis waveform providing unit which provides an analysis waveform obtained by analyzing a temporal change of a pitch contour of a phrase sound source corresponding to a phrase sound source list, selected from phrase sound source lists displayed through a list display window, in the entire sections, through an analysis waveform display window; and
an analysis data providing unit which provides analysis data corresponding to an analysis waveform of the phrase sound source through the analysis data display window.

8. The acoustic sound source analysis device of music using musical elements according to claim 7, wherein the analysis data which is provided by the analysis data providing unit through the analysis data display window includes at least one selected from a group including information for identifying classified sounds in the entire section of the phrase sound source, information about occurrence timings and disappearing timings of classified sounds, and information about a duration.

9. The acoustic sound source analysis device of music using musical elements according to claim 1, wherein the music is Gugak (Korean traditional music) and
the Gugak is at least one selected from a group consisting of Sanjo, Pansori, Jeongak, Minyo (Korean classical folk songs), Japga, Pungmul, Gut music, Gagok, and Sinawi.

10. Anacoustic sound source analysis method of music using musical elements performed in a device including a memory which stores one or more programs to perform acoustic sound source analysis of music using musical elements and one or more processors which performs operations according to one or more programs, the method comprising:
a step of loading a sound source to be analyzed;
a step of dividing the loaded sound source to be analyzed to generate a plurality of phrase sound sources;
a step of analyzing a pitch contour of the phrase sound source and analyzes the phrase sound source by dividing the phrase sound source into a plurality of sections according to a temporal changing pattern of the extracted pitch contour, and
a step of providing analyzed result information.

11. The acoustic sound source analysis method of music using musical elements according to claim 10, wherein in the step of dividing and analyzing the phrase sound source into a plurality of sections, the phrase sound source is divided into major classification sounds according to a pitch contour based on Sigimsae Theory which is the theory for a technique used to connect notes and the major classification sound includes at least one selected from a group including Pyeongeum, Nongeum, Kkukknuneum, Chuseong, Toeseong, and Jeonseong.

12. The acoustic sound source analysis method of music using musical elements according to claim 11, wherein in the step of dividing and analyzing the phrase sound source into a plurality of sections, in the entire sections of the phrase sound, a section in which a pitch contour has a straight linear shape is classified as Pyeongeum, a section in which a pitch contour has a continuous curved line shape is classified as Nongeum, a section in which a pitch contour has a stepped linear combination shape is classified as Kkukknuneum, a section in which a pitch contour has an upward curved shape is classified as Chuseong, a section in which a pitch contour has a downward curved shape is classified as Toeseong, and a section in which a pitch contour has a discontinuous curved shape is classified as Jeonseong.

13. A computer program stored in a computer readable recording medium to allow a computer to execute the acoustic sound source analysis method of music using musical elements according to claim 10.
